(19) United States
(12) Patent Application Publication
(10) Pub. No.: US 2010/0246454 A1
(43) Pub. Date: Sep. 30, 2010

(54) NOVEL TRANSMIT/RECEIVE BALUN STRUCTURE

(75) Inventors: Saied Ansari, Oakland, CA (US); Thai Nguyen, San Jose, CA (US)

Correspondence Address: PERKINS COIE LLP, P.O. BOX 1208, SEATTLE, WA, 98111-1208, US

(73) Assignee: Quantenna Communications, Inc, Sunnyvale, CA (US)

(21) Appl. No.: 12/527,429

(22) PCT Filed: Feb. 14, 2008
(86) PCT No.: PCT/US08/54020

§ 371 Date: Jun. 17, 2010

Related U.S. Application Data
(60) Provisional application No. 60/890,452, filed on Feb. 16, 2007.

(51) Int. Cl. H04B 7/005; H04L 5/16

(52) U.S. Cl. 370/278; 375/219

(57) ABSTRACT

A technique for efficient balun duplexing includes providing a switchless path through a balun. In a receive mode, a transmit path is blocked and signal is directed along a switchless receive path. In a transmit mode, a receive path is blocked and signal is directed along a switchless transmit path.

### BACKGROUND

A balun is an electronic device that converts between balanced and unbalanced electrical signals. Baluns are typically used to achieve compatibility between systems. They are commonly used in modem communications systems, particularly in frequency conversion mixers in cellular phone and data transmission networks.

Traditionally, transmit/receive duplexing associated with a balun is accomplished by deploying a single-pole double-through (SPDT) switch. This architecture relies on low loss through the switch to achieve efficient radio transmission. However, there is normally some through loss that comes from placing the SPDT switch in the through path of an RF signal.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for efficient balun duplexing includes providing a switchless path through a balun. In a receive mode, a transmit path is blocked and signal is directed along a switchless receive path. In a transmit mode, a receive path is blocked and signal is directed along a switchless transmit path.

The description in this paper describes this technique and examples of systems implementing this technique.

### BRIEF DESCRIPTION OF THE DRAWINGS

Examples of the claimed subject matter are illustrated in the figures.

FIG. 1 depicts an example of a TX/RX duplexing balun system.

FIGS. 2 and 3 depict an example of transmission lines that could be used in a TX/RX duplexing balun.

FIG. 4 depicts an example of a TX/RX lattice balun.

FIG. 5 depicts an example of a TX/RX balun system with dual port TX switches.

FIG. 6 depicts a conceptual diagram of the function of a TX/RX duplexing balun.

FIG. 7 depicts a flowchart of an example of a method for TX/RX duplexing in a receive mode.

FIG. 8 depicts a flowchart of an example of a method for TX/RX duplexing in a transmit mode.

### DETAILED DESCRIPTION

In the following description, several specific details are presented to provide a thorough understanding of examples of the claimed subject matter. One skilled in the relevant art will recognize, however, that one or more of the specific details can be eliminated or combined with other components, etc. In other instances, well-known implementations or operations are not shown or described in detail to avoid obscuring aspects of the claimed subject matter.

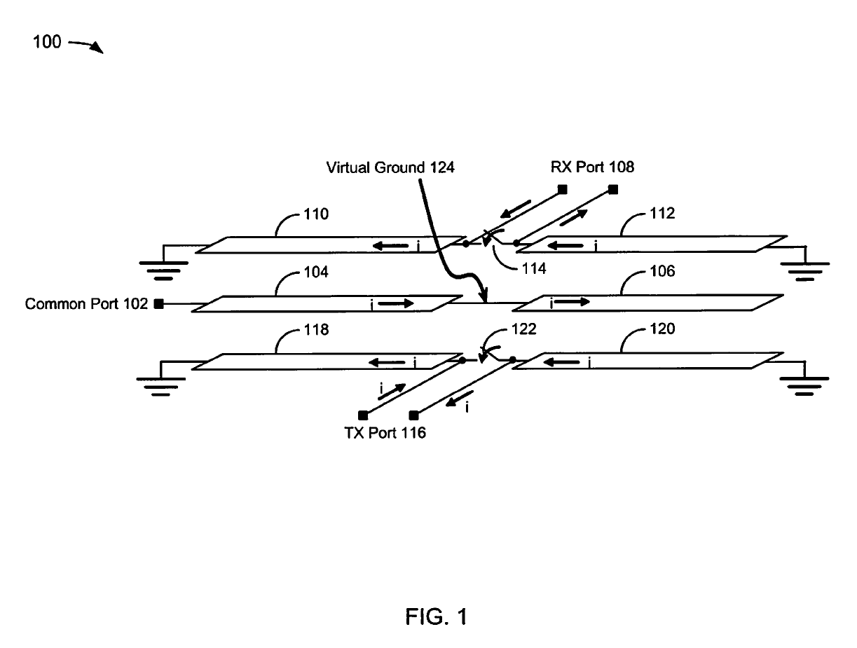

FIG. 1 depicts an example of a TX/RX duplexing balun system 100. The duplexing balun system 100 includes a common port 102, a first common transmission line 104, a second common transmission line 106, a receiver port 108, a first receive (RX) transmission line 110, a second RX transmission line 112, a switch 114, a transmitter port 116, a switch 118, a first transmit (TX) transmission line 120, and a second TX transmission line 122. The components depicted in the example of FIG. 1 may be referred to collectively as a balun, though additional components could be considered to be a part of the balun, and some components may be omitted so long as relevant functionality remains.

One advantage of the duplexing balun system 100 is that the balun component is efficient because signal does not pass through a switch associated with the balun. Moreover, the system is sufficiently simple that it should be implementable on a single CMOS die along with other transceiver components.

In the example of FIG. 1, the common port 102 may be referred to as an unbalanced port. In a wireless implementation, the common port 102 is typically coupled to an antenna (not shown) over which radio frequency (RF) signals are received and transmitted. There is frequently, though not necessarily, a band pass filter (BPF) coupled between the antenna and the common port 102. BPF functionality could also be found in a transmitter, low noise amplifier (LNA), power amplifier (PA), or other component.

In the example of FIG. 1, the first common transmission line 104 and the second common transmission line 106 may include a ¼ wavelength transmission line. Although the common transmission lines 104, 106 are depicted as separate components, it is possible to implement the common transmission lines 104, 106 as a monolithic structure (i.e., as a single transmission line with the indicated functionality). In any case, the first common transmission line 104 is defined as the transmission line (or portion of the transmission line) that is between the common port 102 and a virtual ground 124; the second common transmission line 106 is defined as the transmission line (or portion of the transmission line) that is after the virtual ground 124. As is depicted as an arrow in the example of FIG. 1, current passes from the common port 102, through the first common transmission line 104, through the virtual ground 124, and through the second common transmission line 106. A significance of this current is discussed with reference to the RX and TX transmission lines.

In the example of FIG. 1, the RX port 108 includes two terminals: positive and negative. For illustrative purposes, as is shown by arrows in FIG. 1, the positive and negative terminals of the RX port 108 can be deduced because current flows toward a positive terminal.

In the example of FIG. 1, the first RX transmission line 110 and the second RX transmission line 112 may include a ¼ wavelength transmission line. Although the RX transmission lines 110, 112 are depicted as separate components, it is possible to implement the RX transmission lines 110, 112 as a monolithic structure (i.e., as a single transmission line with the indicated functionality). In any case, the first RX transmission line 110 could be defined as the transmission line (or portion of the transmission line) that is between the negative terminal of the RX port 108 and ground; the second RX transmission line 112 is defined as the transmission line (or portion of the transmission line) that is between the positive terminal of the RX port 108 and ground; or vice versa. As is depicted as an arrow in the example of FIG. 1, current passes from the negative terminal of the RX port 108 through the first RX transmission line 110 to ground, and from ground through the second RX transmission line 112 to the positive terminal of the RX port 108.

In the example of FIG. 1, the switch 114 is shown in an open position, which enables the current flow described with reference to the RX transmission lines 110, 112, above. It should be noted that closing the switch 114 will cause the RX transmission lines 110, 112 to present a high impedance load. This is discussed later with reference to RX and TX states. The switch 114 may include any known or convenient components that enable its switching functionality, including but not limited to one or more transistors.

In the example of FIG. 1, the TX port 116 includes two terminals: positive and negative. For illustrative purposes, as is shown by arrows in FIG. 1, the positive and negative terminals of the TX port 116 can be deduced because current flows toward a positive terminal.

In the example of FIG. 1, the first TX transmission line 118 and the second TX transmission line 120 may include a ¼ wavelength transmission line. Although the TX transmission lines 118, 120 are depicted as separate components, it is possible to implement the TX transmission lines 118, 120 as a monolithic structure (i.e., as a single transmission line with the indicated functionality). In any case, the first TX transmission line 118 could defined as the transmission line (or portion of the transmission line) that is between the negative terminal of the TX port 116 and ground; the second TX transmission line 120 is defined as the transmission line (or portion of the transmission line) that is between the positive terminal of the TX port 116 and ground; or vice versa. As is depicted as an arrow in the example of FIG. 1, current passes from the negative terminal of the TX port 116 through the first TX transmission line 118 to ground, and from ground through the second TX transmission line 120 to the positive terminal of the TX port 116.

In the example of FIG. 1, the switch 122 is shown in an open position, which enables the current flow described with reference to the TX transmission lines 118, 120, above. It should be noted that closing the switch 122 will cause the TX transmission lines 118, 120 to present a high impedance load. This is discussed later with reference to RX and TX states. The switch 122 may include any known or convenient components that enable its switching functionality, including but not limited to one or more transistors.

As was mentioned above, FIG. 1 depicts the switches 114, 122 in an open position. When both of the switches 114, 122 are in the open position, the system 100 may be referred to as being in a TX/RX mode. That is, the system 100 is capable of simultaneous TX and RX. In general, this mode requires some care to implement. Specifically, a LNA must not become saturated, which can occur if power is too great, a filter is insufficient to protect the LNA from saturation, or for other reasons.

In TX mode, the switch 114 is closed, but the switch 122 is open. As was mentioned above, this causes the RX transmission lines 110, 112 to present a high impedance load. When this occurs, signal from the TX port 116 is, following Faraday's Law, directed toward the common port 102. Specifically, balanced TX currents will induce a signal on the common (unbalanced) port. The TX signal will also induce currents on the RX transmission lines. The currents on the unbalanced transmission lines will induce currents on the RX transmission lines, but in the opposite direction. The node shorted by the switch 114 will, in effect, become a current canceling node, resulting in minimal loading effects of the RX transmission lines on the rest of the structure. Since the signal is directed, it need not pass through a switch. Advantageously, directing the signal eliminates the loss associated with passing a signal through a switch.

In RX mode, the switch 114 is open, but the switch 122 is closed. As was mentioned above, this causes the TX transmission lines 118, 120 to present a high impedance load. When this occurs, signal from the common port 102 is, following Faraday's Law, directed toward the RX port 108. The node shorted by switch 122, in effect, becomes a current canceling node, resulting in minimal loading effects of the RX transmission lines on the rest of the structure. The current canceling node will present a high impedance at the operating frequency of the balun and introduce minimal loading effects on the rest of the circuit. Since the signal is directed, it need not pass through a switch. Advantageously, directing the signal eliminates the loss associated with passing a signal through a switch.

As should be apparent from this description, control circuitry (not shown) can set the system 100 to any of the modes by opening or closing the switches 114, 122 in a known or convenient manner. The duplexing balun works as a TX balun when the RX port is shorted, as an RX balun when the TX port is shorted, and as a simultaneous TX/RX balun when neither port is shorted. Shorting both ports would generally result in an off state, which may or may not be considered a “useful” state.

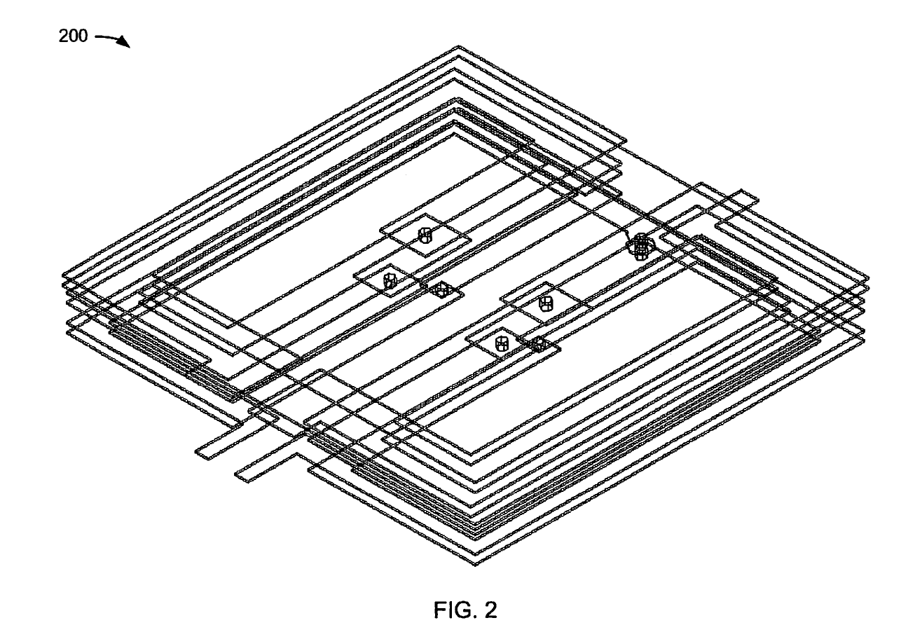

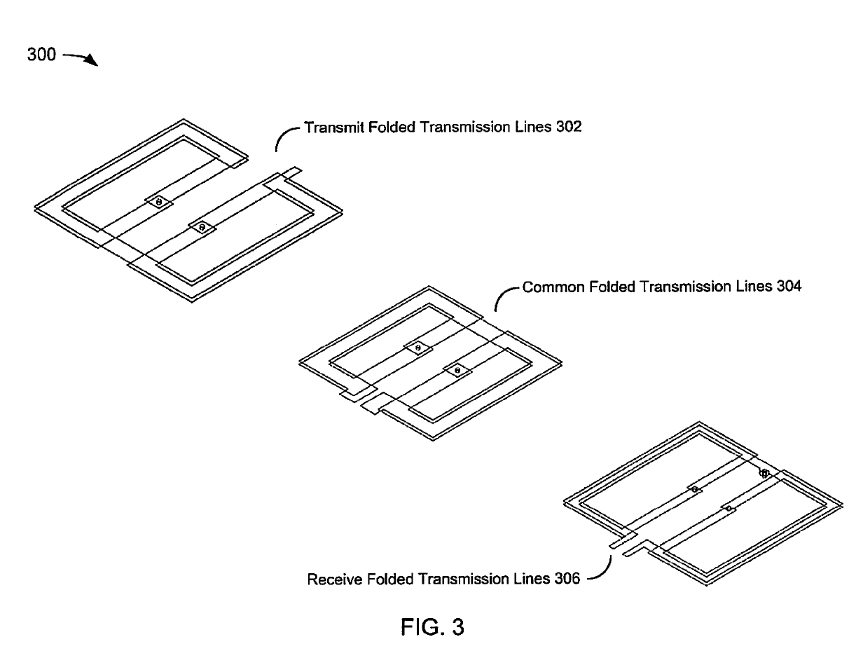

FIG. 2 depicts an example of transmission lines 200 that could be used in a TX/RX duplexing balun. For the purpose of example, the transmission lines are folded transmission lines. Since, in the example of FIG. 2, it is relatively difficult to discern the transmission lines 200, portions of the transmission lines 200 are depicted separately in the example of FIG. 3. In the example of FIG. 3, examples of transmit folded transmission lines 302, common folded transmission lines 304, and receive folded transmission lines 306 can be seen.

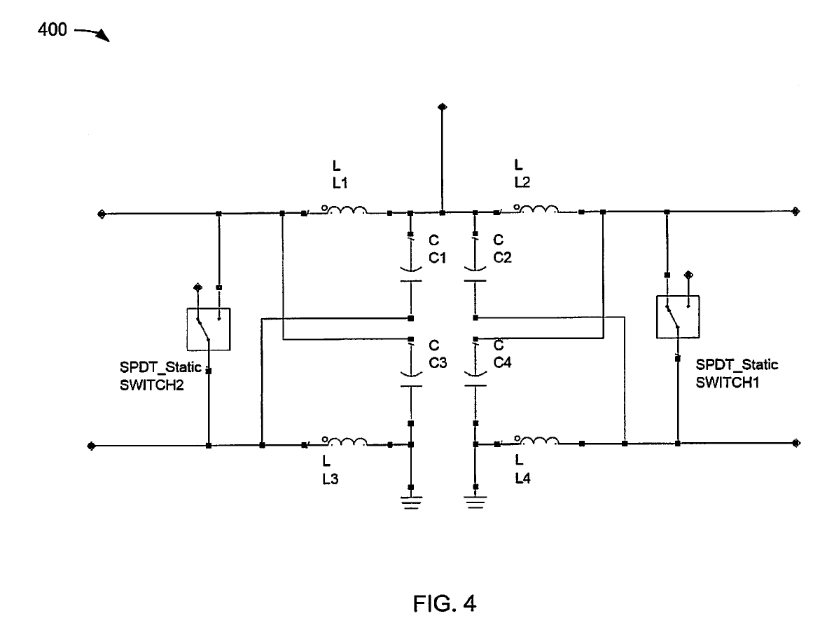

FIG. 4 depicts an example of a TX/RX lattice balun 400. Conceptually, the TX/RX lattice balun 400 is similar to the balun described with reference to FIG. 1. Specifically, when Switch1 is in the closed state and Switch2 is open, parallel LC tanks L2/C2, and L4/C4 resonate at the operating frequency and present a high impedance load to the common port. In this state, any signal that appears at the common port will be directed to the receive port. When Switch2 is closed and Switch1 is open, parallel LC tanks L1/C1 and L3/C3 resonate at the operating frequency and present a high impedance load to the common port. In this state, any signal that appears at the balanced transmit ports is directed to the common port.

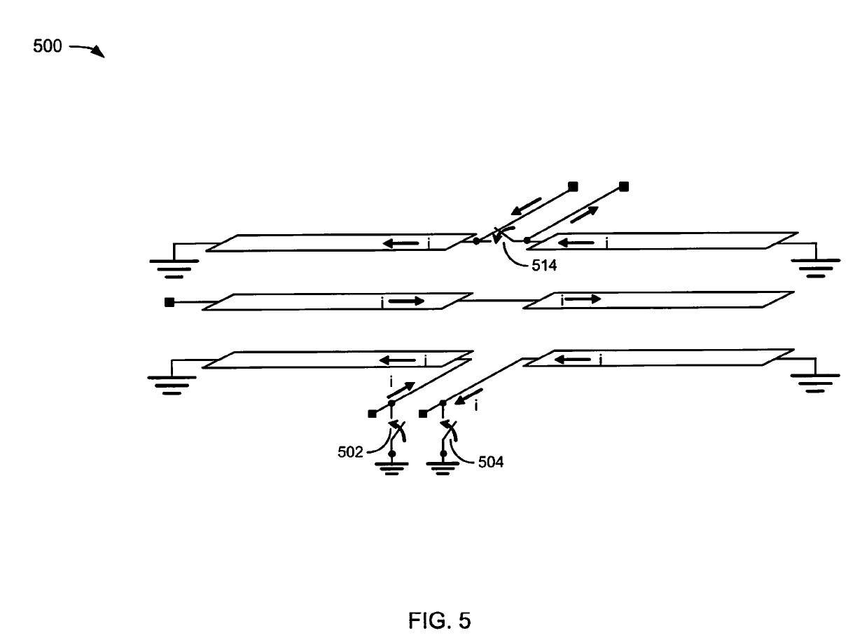

FIG. 5 depicts an example of a TX/RX balun system 500 with dual TX port switches. FIG. 5 is quite similar to FIG. 1 (similar components are not described again here). The TX/RX balun system 500 includes dual TX port switches 502, 504 (in lieu of the switch 122 of FIG. 1). The circuit operates in TX mode when both switches 502, 504 are in the open state, while switch 514 is closed. RX operation takes place when the switch 514 is open while the switches 502, 504 are in the closed state. The fundamental operation of the circuit with dual port switches is the same as the original circuit, with the advantage of each switch being subject to ‘half’ the differential voltage swing. This may result in a smaller device, hence, less parasitic loading. The dual switch implementation can be applied to either or both ports.

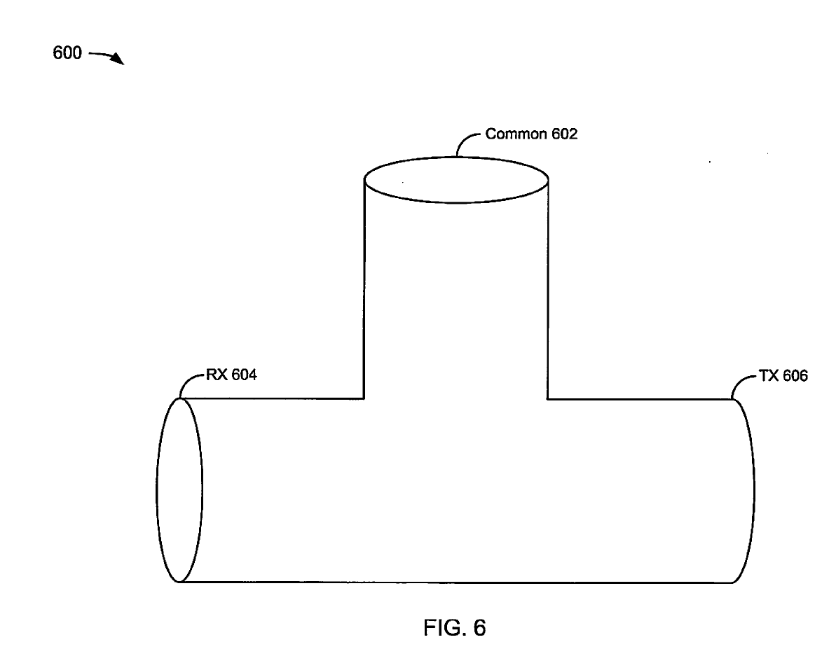

FIG. 6 depicts a conceptual diagram 600 of the function of a TX/RX duplexing balun. In the example of FIG. 6, a common port 602, RX port 604, and TX port 606 are depicted as tubes connecting to one another. Data is passed through the tube from the common port 602 to the RX port 604, or from the TX port 606 to the common port 602. Conceptually, if the TX port 606 is open when the common port 602 is sending data to the RX port 604, there may be some loss through the TX port 606. However, if the TX port 606 is blocked when sending data from the common port 602 to the RX port 604, the loss is reduced or eliminated. The same is true when sending data from the TX port 606 to the common port 602 if the RX port 604 is blocked.

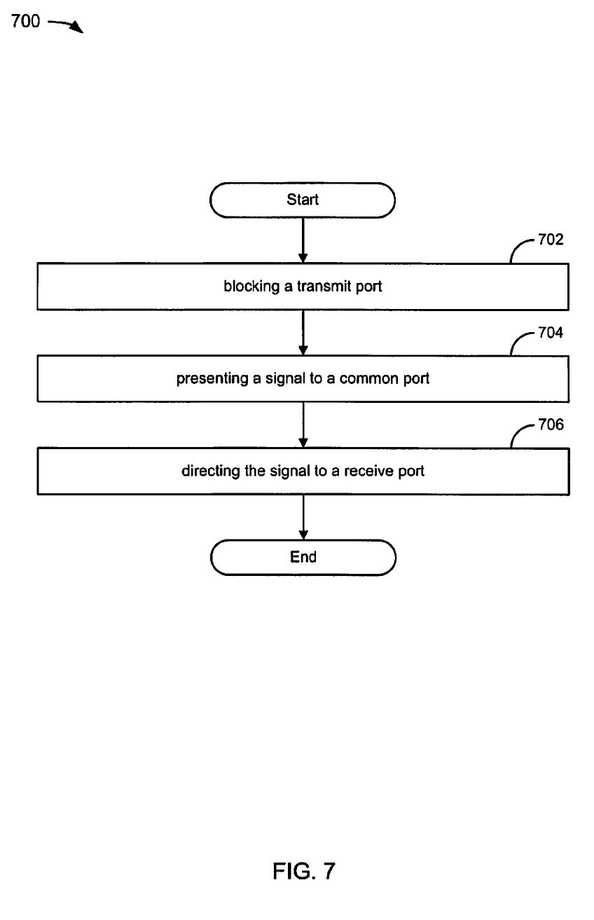

FIG. 7 depicts a flowchart 700 of an example of a method for TX/RX duplexing in a receive mode. Although this figure depicts functional modules in a particular order for purposes of illustration, the process is not limited to any particular order or arrangement. One skilled in the relevant art will appreciate that the various modules portrayed in this figure could be omitted, rearranged, combined and/or adapted in various ways.

In the example of FIG. 7, the flowchart 700 starts at module 702 with blocking a transmit port. The transmit port may be blocked by resonating the transmit port out of the circuit. For example, the transmit path could be switched to ground, thereby presenting the transmit path as a high impedance load.

In the example of FIG. 7, the flowchart 700 continues to module 704 with presenting a signal to a common port. For example, a signal may be received on an antenna that is operationally connected to the common port.

In the example of FIG. 7, the flowchart 700 continues to module 706 with directing the signal to a receive port. If the transmit path is presenting as a high impedance load, the signal can be directed more effectively along a common transmission line that is coupled to both the receive path and the transmit path. Since the signal is directed, there is no need to pass the signal through, for example, an SPDT switch that is closed when the signal is allowed along a path. Thus, the signal can be directed along a switchless path to the receive port.

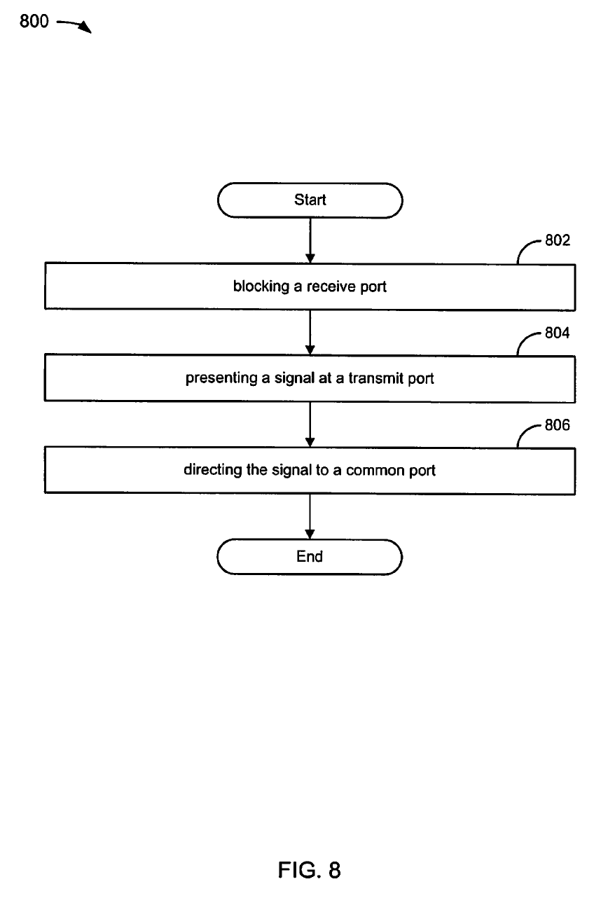

FIG. 8 depicts a flowchart 800 of an example of a method for TX/RX duplexing in a transmit mode. In the example of FIG. 8, the flowchart 800 starts at module 802 with blocking a receive port; continues to module 804 with presenting a signal at a transmit port; and ends at module 806 with directing the signal to a common port.

Systems described herein may be implemented on any of many possible hardware, firmware, and software systems. Typically, systems such as those described herein are implemented in hardware on a silicon chip. Algorithms described herein are implemented in hardware, such as by way of example but not limitation RTL code. However, other implementations may be possible. The specific implementation is not critical to an understanding of the techniques described herein and the claimed subject matter.

To further improve the performance, we can add loop back calibration or pre-distortion. These two techniques could be used individually or combined to potentially improve system performance.

Other known or convenient amplifier efficiency enhancement techniques may be used with the amplifiers described herein. For example, envelop tracking of the supply voltage of the amplifiers could be implemented. As another example, for MOS amplifiers, there is a technique to improve efficiency by dynamic biasing a gate. Similarly, one could dynamically bias a BJT amplifier base. We can use these efficiency improvement techniques for PAs to get better performance.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

1. A device including a balun comprising:
a common port;
a first common transmission line operationally connected to the common port;
a first receive (RX) transmission line coupled to the first common transmission line;
a first transmit (TX) transmission line coupled to the first common transmission line;
a positive RX port operationally connected to the first RX transmission line;
a positive TX port operationally connected to the first TX transmission line;
a second common transmission line operationally connected to the first common transmission line;
a second RX transmission line coupled to the second common transmission line;
a second TX transmission line coupled to the second common transmission line;
a negative RX port operationally connected to the second RX transmission line;
a negative TX port operationally connected to the second TX transmission line;
an RX switching module operationally connected to the positive RX port and the negative RX port;
a TX switching module operationally connected to the positive TX port and the negative TX port;
wherein, in operation,
in a receive state the RX switching module is open and the TX switching module is closed, the TX transmission lines present a high impedance load, and signal entering the common port will induce current in the RX transmission lines;
in a transmit state the TX switching module is open and the RX switching module is closed, the RX transmission lines present a high impedance load, and signal entering the common port will induce current in the TX transmission lines.

2. The device of claim 1, wherein the first common transmission line, the first RX transmission line, the first TX transmission line, the second common transmission line, the second RX transmission line, and the second TX transmission line are ¼ wavelength transmission lines.

3. The device of claim 1, wherein the first RX transmission line is electromagnetically coupled to the first common transmission line, the second RX transmission line is electromagnetically coupled to the second common transmission line.

4. The device of claim 1, wherein the first TX transmission line is electromagnetically coupled to the first common transmission line, the second TX transmission line is electromagnetically coupled to the second common transmission line.

5. The device of claim 1, wherein the first common transmission line and the second common transmission line comprise common folded transmission lines.

6. The device of claim 1, wherein the first common transmission line and the second common transmission line are a monolithic structure.

7. The device of claim 1, wherein the first RX transmission line, the first TX transmission line, the second RX transmission line, and the second TX transmission line are grounded.

8. The device of claim 1, wherein, in operation, current flows from the common port through the first common transmission line to a virtual ground, and from the virtual ground through the second common transmission line.

9. The device of claim 1, wherein, in operation, simultaneous transmit and receive signals pass through the common port.

10. The device of claim 1, wherein, in operation, signal passes from the common port to one or more of the positive RX port, the positive TX port, the negative RX port, and the negative TX port, without passing through a switch.

11. The device of claim 1, wherein the TX switching module includes a first switch and a second switch, and wherein the TX switching module is open when both the first switch and the second switch are open and the TX switching module is closed when both the first switch and the second switch are closed.

12. The device of claim 1, wherein when the TX switching module is closed, the first TX transmission line, the second TX transmission line, and the TX port resonate out of the device.

13. The device of claim 1, wherein the signal includes a radio frequency (RE) signal.

14. A system comprising:
an antenna;
a transmit/receive (TX/RX) duplexing balun coupled to the antenna;
a transmitter coupled to the TX/RX duplexing balun;
a receiver coupled to the TX/RX duplexing balun;
a TX/RX duplexing control circuit coupled to the TX/RX duplexing balun;
wherein, in operation,
in a receive mode, the TX/RX duplexing control circuit sets the TX/RX duplexing balun to an RX state, a first radio frequency (RF) signal is received on the antenna, the first RF signal is directed through the TX/RX duplexing balun to the receiver;
in a transmit mode, the TX/RX duplexing control circuit sets the TX/RX duplexing balun to a TX state, a second RF signal is presented at the transmitter, the second RF signal is directed through the TX/RX duplexing balun to the antenna.

15. The system of claim 14, further comprising a band pass filter (BPF) coupled between the antenna and the TX/RX duplexing balun.

16. The system of claim 14, further comprising a switchless signal path from the antenna to the transmitter and from the antenna to the receiver.

17. A method comprising:
blocking a transmit port;
presenting a signal to a common port;
directing the signal to a receive port;
wherein, the signal is directed to the receive port without passing through a switch.

18. The method of claim 17, wherein the signal is a first signal, further comprising:
blocking the receive port;
presenting a second signal at the transmit port;
directing the second signal to the common port.

19. The method of claim 17, further comprising presenting a high impedance load to block the transmit port.

20. The method of claim 17, wherein the signal is a radio frequency (RF) signal.
